(19) United States
(12) Patent Application Publication
(10) Pub. No.: US 2011/0097692 A1
(43) Pub. Date: Apr. 28, 2011

(54) Business Risk Training Game

(76) Inventor: Joseph B. Homan, Schwenksville, PA (US)

(21) Appl. No.: 12/762,954

(22) Filed: Apr. 19, 2010

Related U.S. Application Data
(60) Provisional application No. 61/170,268, filed on Apr. 17, 2009.

(51) Int. Cl. G09B 19/22

(52) U.S. Cl. 434/129

(57) ABSTRACT

A business risk/reward training game simulates and trains department managers in a multi-department business enterprise the concepts of risk and reward, and their balance to maximize profits, using simulated possible risk scenarios, dice to determine how many possible risk events a participant may have to deal with in view of budgets the participants select, to minimize risk balanced against maximizing revenues and profits.

### CROSS REFERENCE TO RELATED APPLICATIONS

This application claims priority on U.S. Ser. No. 61/170,268, filed Apr. 17, 2009, which is incorporated by reference herein.

### BACKGROUND OF THE INVENTION

A portion of the disclosure of this patent document contains material which is subject to copyright protection. The copyright owner has no objection to the facsimile reproduction by anyone of the patent document or the patent disclosure, as it appears in the Patent and Trademark Office file or records, but otherwise reserves all copyright rights whatsoever.

The present invention relates to a game, and a method for playing such a game, which simulates the risks and rewards involved in managing a multi-department business enterprise to educate and train players the concepts of risk and reward, and their relationship.

In running a business enterprise, one must balance the two interdependent elements of risk mitigation and profits. Complete risk mitigation is a possibility, but that would mean that the business enterprise does nothing, makes nothing, and sells nothing. This result would be unacceptable and very unprofitable. The other extreme is to throw caution completely to the wind and not pay any attention to risk and quality. This, too, would be unacceptable and eventually completely unprofitable, and may even create a liability which exceeds the profits and even revenue.

Training business enterprise managers and other employees on the appropriate amount of risk and risk-avoidance measures to take in a business enterprise is typically done through on-the-job training, which can be costly and create real risk to the company, and negative consequences to the company.

There does not appear to be any risk and renewal game to simulate the risks and rewards involved in managing a multiple department business enterprise, which can serve as a training tool.

### SUMMARY OF THE INVENTION

The present invention provides a game which simulates the real world decisions, and effects of those decisions, of business enterprise department managers with regard to risk-taking, risk mitigation, and profit of the entire business enterprise.

The present invention provides a valuable training tool so that department managers can learn about risk mitigation in a simulated environment, instead of a real-world environment involving real-world consequences of risk mitigation and profit. The simulation helps players to understand the value of prudence in risk mitigation, balanced with calculated data-driven risk taking.

The present invention recognizes that the element of risk involves an element of possibility and perhaps even randomness in whether a risk matures into an actual loss to the business enterprise. In the present invention, in one form, the probability or randomness is simulated by a random number generator device, which may be one or more die of the six-sided cube-type used in board games.

The use of a random number generator, such as dice, is to illustrate that unless one takes the unacceptable path of total risk aversion there will always be some element of risk. However, the simulation demonstrates in the latter rounds through the use of departmental budgetary requests that with proper data analysis the risk can be properly managed and the business can attain a maximization of profits. The game demonstrates that companies can squander precious profits by throwing unnecessary money at perceived risk. This is illustrated by the Nagging Feeling cards used in the game. The “Nagging Feeling” cards simulate a potential risk that may have little or no basis-in-fact, but may solely be a hunch by a department head.

The simulation also takes into account that all risk is not managed solely in the departments, but that some risk lies between the departments in the space between the departments, which is on a company-wide basis. This is illustrated by the larger company risk mitigation number which exceeds the sum of the departmental risk mitigation amounts. For example, the total company risk number could be assigned a number of 60, even though the sum of the departmental risk amounts is only 50. In the example, about 10 of the amount, or about twenty percent of total company-wide risk, would not be caught solely by mitigating risk within departments.

A key aspect that is simulated is the variability of revenue, not in a random sense but in a skilled sense, and that is the reason for using a skill-based revenue determiner, such as a dart and dart board, target areas representing different annual revenue the entire firm would realize. One example of a dart board would be a center region, a first ring, and a second ring, assigned respective revenue values of 1000, 750, and 500. Participants have a chance, using their skill, to better their profit margin and the sales revenue rather than the simulation simply giving them their profits randomly. They would have to work for the revenue in the real world and the simulation does the same.

The game simulation also demonstrates that even if the risk is not completely mitigated bad things do not always happen. This is very real world and is illustrated by a company risk impact. Some of the company risk cards have no adverse effect so risk is managed. However, some, but not all, have negative consequences in varying degrees just like the real world. One other key simulated item is peoples' understanding of risk and the progression that a company can undertake to change their culture regarding risk when everyone is aware of the data and trained how to approach risk in a balanced, prudent manner to yield the best results for customers, stockholders, and the company.

The present invention provides a simulation game for one or more business cycles of a business enterprise, in which a cycle can represent one year, for example. In the first year, the players assume the role of department heads, decide on how much to budget and spend on risk mitigation for their departments in view of perceived risks, use a random number generator device (such as one or more game die) which is used to determine whether their decided budget covered the departmental risk, determine through risk impact cards whether any department risks became actual expense items from actual risk events, use a skill device to determine how much revenue the company received during that business cycle, and then calculate a net profit based on the revenue from the skill device minus the budget spent for risk mitigation for all departments, and also, minus any actual expense items from actual risk events. In the first business cycle, the players make their decisions independently, in a siloed environment without contact or communication with other department heads. In the first cycle, the game may also simulate the possible occurrence of a company-wide risk event in addition to the individual department risk events, and whether that company-wide risk event resulted in a company-wide expense which affects net profit. In successive rounds or cycles the players can communicate with other department manager players to cooperate and help them decide on their respective risk mitigation department budgets for these cycles.

In playing the risk simulation game through one or more rounds or cycles, the players gain an important perspective on the role of risk and risk mitigation within departments, and between the departments on a company-wide basis. The players also learn that the occurrence of risk events (or loss events) is at least partly randomly determinative, and that revenue is at least partly skill determinative.

More specifically, in cycle or year 1, players are in an isolated siloed mentality with little or no understanding of risk. In cycle or year 2, the players communicate and have a better understanding or risk, but are still somewhat isolated and siloed. In cycle or year 3, the players undergo training and functional communication to learn a better understanding of risks and tools to mitigate risks. In cycle or year 4, comprehensive risk management training provides internalization of tools for functional communication, understanding of risks, and how to mitigate risk as a cross-functional team.

The present invention provides a method of playing a risk/reward game to simulate the impact of risk and reward events by players while managing different departments of a multi-department business enterprise, comprising the steps of:
a. assigning each player to be the head of a different department in a business enterprise;
b. providing each player with a risk indicia representing a possible risk-event associated with the player's department in the enterprise;
c. receiving from each player a requested budget amount to spend to address risk associated with the player's department based on the player's perceived risk;
d. providing each player with a physical random number-generated device to generate a random number value, the range of possible random number values being determined by the player's requested budget amount;
e. generating a random number value for each player using the random number generator device;
f. determining whether the
g. the impact of risk and reward events by players while managing different departments of a multi-department business enterprise, comprising:
department identification signs which identify different departments in a business enterprise and where a player assigned to be the department head will be located during the game;
h. a plurality of risk indicia cards random number value for each player is at least as great as a department risk mitigation value associated with the player's respective department, and if not at least as great, provide each such player with a number of department-specific risk impacts, the number being dependent on the amount that such department risk mitigation value is less than the random number value, wherein each said risk impact indicia represent the cost to the enterprise if a risk event occurs;
i. calculating the value of the total cost to the business enterprise of all of the risk events of the departments of step f;
j. determining a value of the total income to the business enterprise based on a physical skill event by at least one of the players using physical game devices, the total income value being dependent on the player's performance on the skill event; and
k. determining a value of the profit for the business enterprise by calculating the difference between the total income value of step h and the total cost value of step g.
l. The present invention provides a risk/reward game to simulate for each department, each risk indicia card for a department representing a possible risk event associated with the player's department in the enterprise,
m. a budget request card for each department for recording from each player a requested budget amount to spend to address possible risk events associated with the player's department;
n. a physical random number-generated device, to generate a random number value, the range of possible vendor number values being determined by the player's requested budget amount, and used by a player to generate a random number;
o. a score card having locations for recording the random number value for each player, evaluating whether the random number value is at least as great as a department risk mitigation value associated with the player's respective department, determining any difference between the random number value and department risk value to arrive at a number of risk events attributable to the player, and wherein the scorecard also has locations for recording other number values in the rest of the game;
p. a plurality of department-specific risk impact indicia for each department to be given to respective department player, wherein the number of department-specific risk impact indicia given to a player is dependent on the amount that such department risk mitigation value is less than the random number value, wherein each risk impact indicia has a value which represents the cost to the enterprise if a risk event occurs;
q. wherein the score card has locations for recording the calculated value of the total cost to the enterprise of all of the risk events of the departments;
r. a physical skill device to be used by at least one of the players for determining the value of the total income to the enterprise based on a physical skill event by at least one of the players using the physical skill device, the total income value being dependent on and proportional to the player's skill and performance using the skill device;
s. wherein the net profit to the business enterprise is determined by the difference between the total income value, minus the sum of the department budget requests, and minus the total values of the risk events that have actually occurred as indicated by the values of the costs of the risk events for all of the players and recorded on the scorecard.

### BRIEF DESCRIPTION OF THE DRAWINGS

FIG. 1 is a plan of a room layout for the players to play the simulated risk game according to an embodiment of the invention;

FIGS. 2A, 2B and 2C show one set place holders for the department manager players, one set of which can be used for the table area of FIG. 1, and another set for the functional area of FIG. 1;

FIGS. 3A-3G show risk indicia cards, sometimes called “nagging feeling” cards, for each department manager, to advise or remind them of business risks that relate to their department, which they should consider in arriving at a budget amount;

FIG. 3H shows a risk indicia or “nagging feeling” card for the entire business enterprise;

FIGS. 4A-4C show department risk mitigation budget request cards used by the various department manager players to enter budget amounts to spend to mitigate risk;

FIGS. 5A-5D show company risk-impact cards which contain the actual loss values associated with a risk event actually taking place;

FIG. 6 is a scorecard used to enter information and values throughout the game, one scorecard to be issued for each cycle or year;

FIGS. 7, 8, and 9, are presentation posters to convey information to the game players;

FIG. 10 is a training aid comprising a series of seven (7) cells, starting from the upper-left and proceeding to the upper-right, and then the lower-left proceeding to the lower-right, to be shown in sequence to the players directly preceding year 3; and

FIG. 11 shows a dart board used for the skill event, standard dice, a timer, and a calculator.

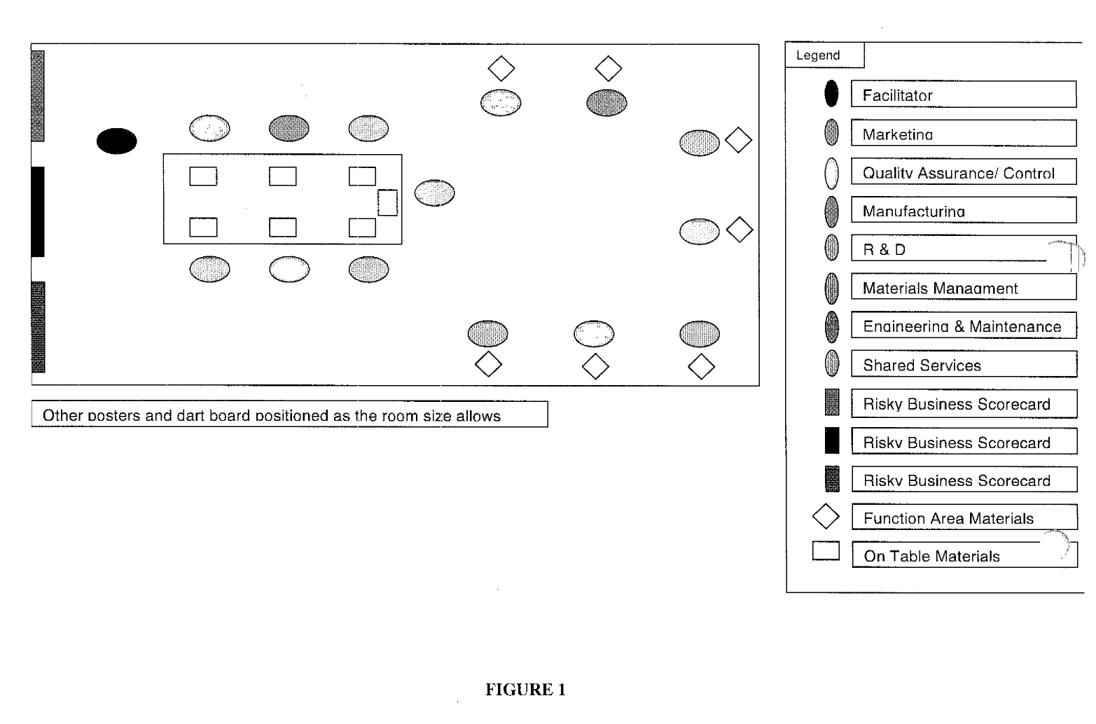

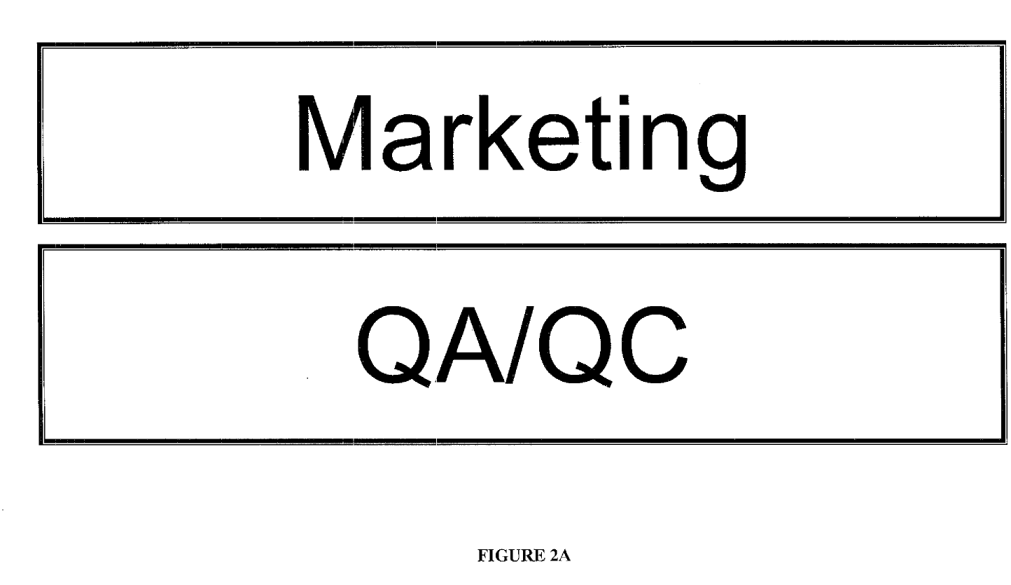

### DETAILED DESCRIPTION OF A PREFERRED EMBODIMENT

The present invention provides a method of playing a risk/reward game to simulate the impact of risk and reward events by players while managing different departments of a multi-department business enterprise, comprising the steps of:
a. assigning each player to be the head of a different department in a business enterprise;
b. providing each player with a risk indicia representing a possible risk-event associated with the player's department in the enterprise;
c. receiving from each player a requested budget amount to spend to address risk associated with the player's department based on the player's perceived risk;
d. providing each player with a physical random number-generated device to generate a random number value, the range of possible random number values being determined by the player's requested budget amount;
e. generating a random number value for each player using the random number generator device;
f. determining whether the random number value for each player is at least as great as a department risk mitigation value associated with the player's respective department, and if not at least as great, provide each such player with a number of department-specific risk impacts, the number being dependent on the amount that such department risk mitigation value is less than the random number value, wherein each said risk impact indicia represent the cost to the enterprise if a risk event occurs;
g. calculating the value of the total cost to the business enterprise of all of the risk events of the departments of step f;
h. determining a value of the total income to the business enterprise based on a physical skill event by at least one of the players using physical game devices, the total income value being dependent on the player's performance on the skill event; and
i. determining a value of the profit for the business enterprise by calculating the difference between the total income value of step h and the total cost value of step g.

The method may further include the step of determining whether the total of the random numbers generated in step e is at least as great as an enterprise-wide risk mitigation value, and if not at least as great, providing to the players a number of enterprise-wide risk impact indicia, the number being dependent on the amount that such enterprise-wide mitigation value is less than a specific enterprise-wide set value, wherein said enterprise-wide risk impact indicia represents the cost to the business enterprise if a risk event occurs, and wherein step g includes calculating a value of the total cost to the business enterprise, which includes the cost of the enterprise-wide risk event. The step of providing each player with a physical random number generator may comprise providing each player with a number of game die the number being dependent on the player's requested budget amount for the player's department. The step h may comprise providing a physical dart board with target areas having assigned different total income values, and at least one dart. The method may further include the step of precluding communication between players in the game throughout the steps, to simulate players working independently in their own departments without communication or cooperation with other departments. The method may further include requiring the players to communicate during the game to foster cooperation in each player in requesting a budget amount for each player's department. The method may a first round of play of steps a-i, during which players are precluded from communication, and a second round of play repeating steps h-i, during which players are required to communicate to foster communication and cooperation in each player requesting a budget amount for each player's department. The method may include a third round of play repeating steps h-i, and including the step of communicating to the players the concept of the game to help them understand how to maximize the net profit before the third round. The method may include a fourth round of play repeating steps h-i, and including the step of requesting players to engage in self-critical analysis and to identify factors they perceive important in improving performance, before the fourth round.

The present invention provides a risk/reward game to simulate the impact of risk and reward events by players while managing different departments of a multi-department business enterprise, comprising:
a. department identification signs which identify different departments in a business enterprise and where a player assigned to be the department head will be located during the game;
b. a plurality of risk indicia cards for each department, each risk indicia card for a department representing a possible risk event associated with the player's department in the enterprise,
c. a budget request card for each department for recording from each player a requested budget amount to spend to address possible risk events associated with the player's department;
d. a physical random number-generated device, to generate a random number value, the range of possible vendor number values being determined by the player's requested budget amount, and used by a player to generate a random number;
e. a score card having locations for recording the random number value for each player, evaluating whether the random number value is at least as great as a department risk mitigation value associated with the player's respective department, determining any difference between the random number value and department risk value to arrive at a number of risk events attributable to the player, and wherein the scorecard also has locations for recording other number values in the rest of the game;
f. a plurality of department-specific risk impact indicia for each department to be given to respective department player, wherein the number of department-specific risk impact indicia given to a player is dependent on the amount that such department risk mitigation value is less than the random number value, wherein each risk impact indicia has a value which represents the cost to the enterprise if a risk event occurs;
g. wherein the score card has locations for recording the calculated value of the total cost to the enterprise of all of the risk events of the departments;
h. a physical skill device to be used by at least one of the players for determining the value of the total income to the enterprise based on a physical skill event by at least one of the players using the physical skill device, the total income value being dependent on and proportional to the player's skill and performance using the skill device;
i. wherein the net profit to the business enterprise is determined by the difference between the total income value, minus the sum of the department budget requests, and minus the total values of the risk events that have actually occurred as indicated by the values of the costs of the risk events for all of the players and recorded on the scorecard.

The physical random number generator may comprise a number of game die, and wherein the number of game die used by the player is determined by the player's requested budget amount. The skill device may comprise a physical dart board having target areas with different values, which target areas with higher values being smaller in size and more difficult to obtain, and at least one dart. The game may further include a number of enterprise-wide risk impact indicia each representing the cost to the business enterprise if a risk event occurs, wherein the number of enterprise-wide risk impact indicia being given to the players is determined by how much greater a specific enterprise-wide set value is greater than the total of the random numbers for all players, and wherein the net profit of the enterprise is determined by also subtracting the cost of the business enterprise risk impact indicia given to the players.

A preferred embodiment of the invention will now be described, in which the game is called “Risky Business”, and is run by a Facilitator and is played by seven (7) department managers. The departments are: Marketing, Quality Assurance/Quality Control, Manufacturing, R&D (Research & Development), Materials Management, Engineering & Maintenance, and Shared Services. The number and names of the departments can, of course, be changed to match more closely the particular industry type and organization. The invention is not limited to the preferred embodiment described, and is merely one way of practicing the invention.

The preferred embodiment will be described in the context of what the Facilitator would do to organize and run the game, and what the Facilitator would say to explain the game and instruct the players to play the game. The name of the company is “Happipastry”, and is in the business of making and selling pastry products.

### OBJECTIVES

Through active participation in this simulation, participants will gain the knowledge necessary to avoid the following when dealing with risk:
Stakeholders being self-serving (knowingly or unknowingly)
Stakeholders blocking intentionally or not
Leaders not communicating a common goal widely enough thereby perpetuating silos
Never enough time to be comfortable
Using time to not to have to make a decision
The understanding of risk (common understanding)
The variable and changing nature of risk
The outside influences/history surrounding risk
How to maximize profits while managing risk

### Time/Personnel Required

1 hour for 1^{st} three years
7 people plus a facilitator and support person

### Materials Needed

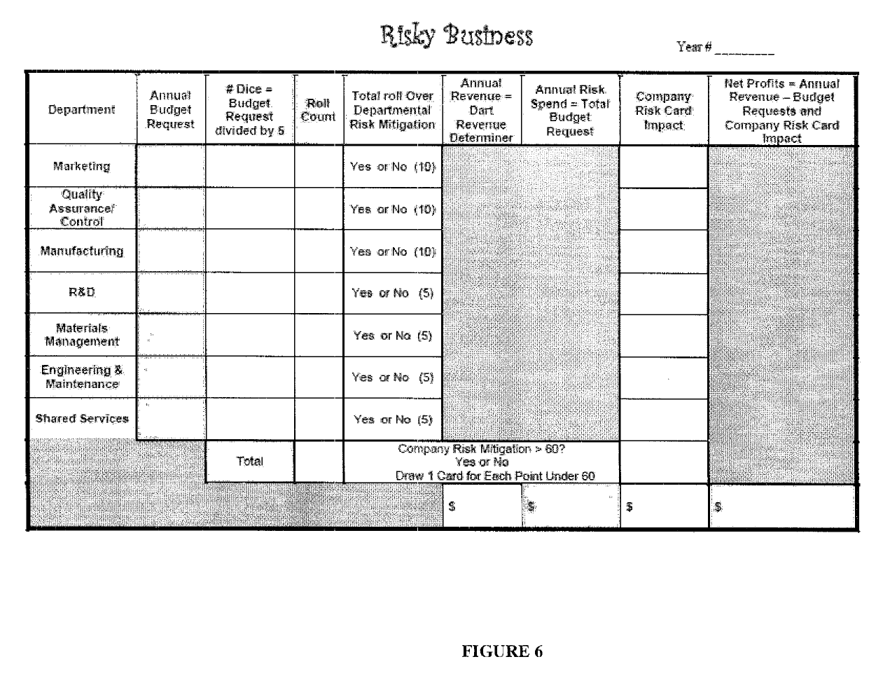

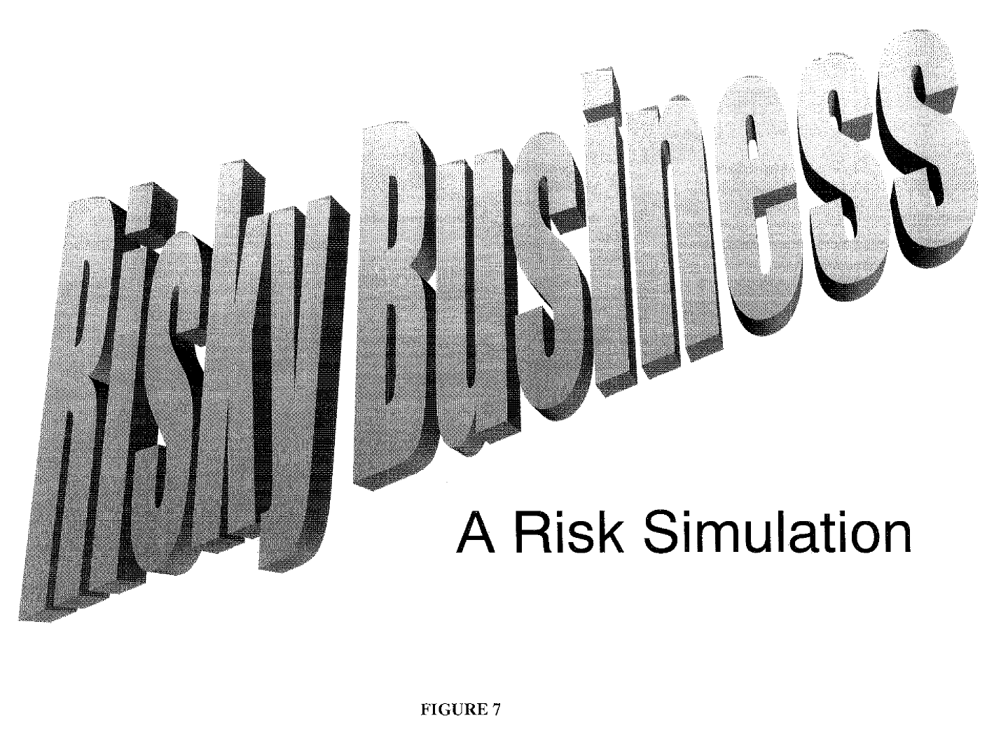

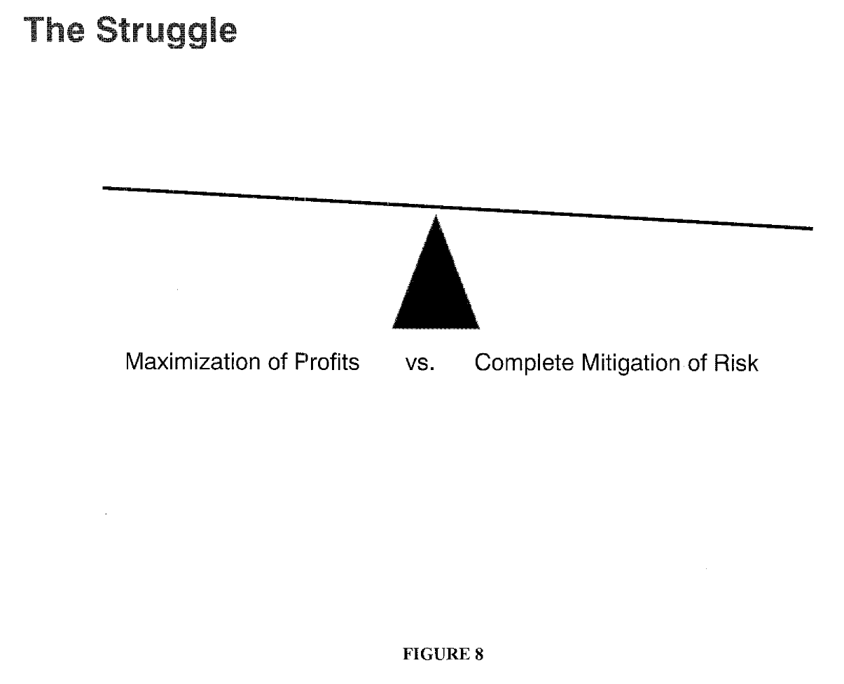

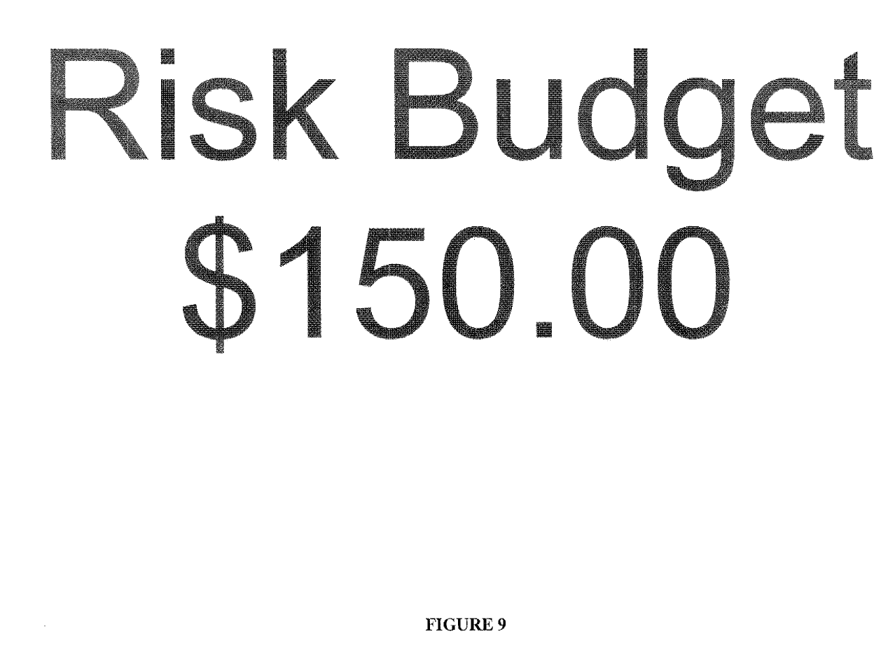

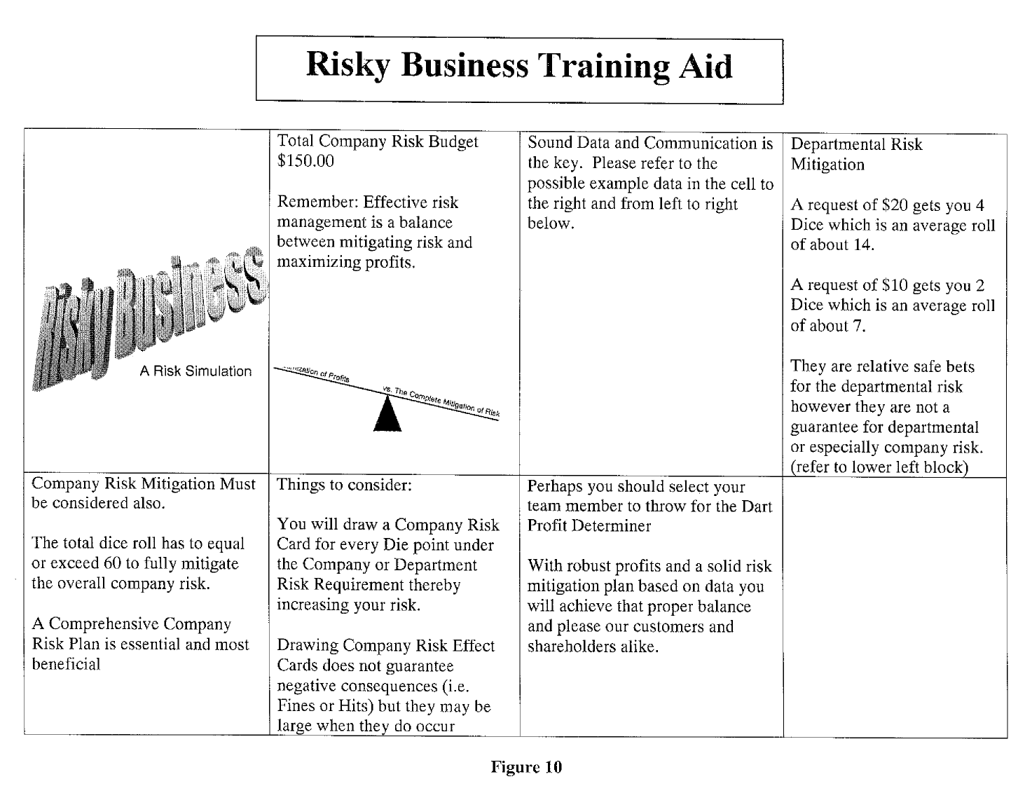

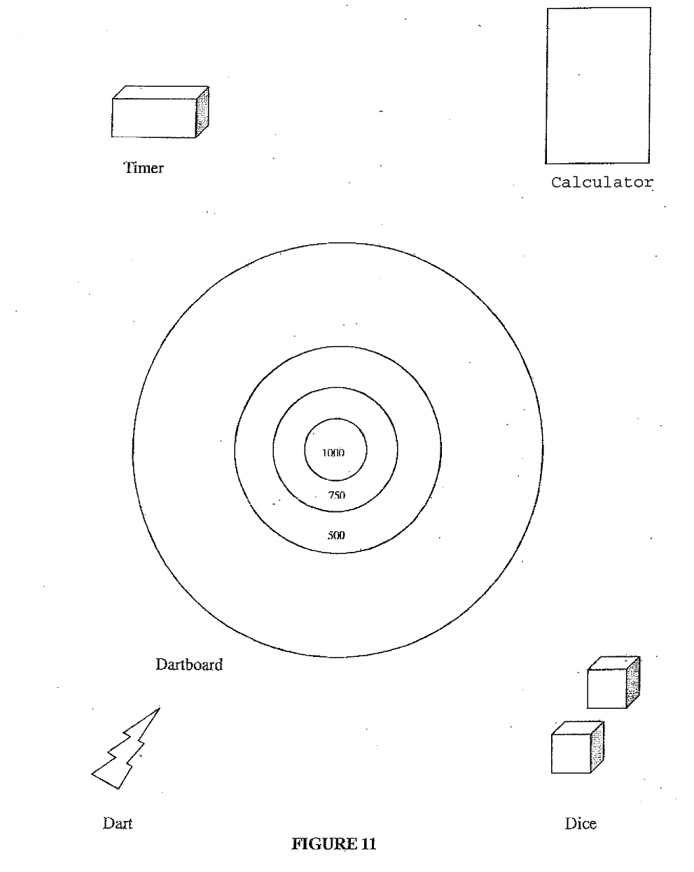

Seventy (70) 6-sided dice (FIG. 11)
Flipchart markers
Dry erase markers and an eraser
4 dry-erase Risky Business scoreboards (FIG. 6; one for each year 1, 2, 3, and 4)
1 debrief flip chart (pre-made in marker) (FIG. 10)
1 timing device (FIG. 11)
1 calculator (FIG. 11)
9 pens
1 dartboard for gross profit or revenue determination (FIG. 11)
Posters:
   Risky Business poster (FIG. 7)
   “The Struggle” poster (FIG. 8)
   “Risk Budget $150” poster (FIG. 9)

### At Least 10 Minutes Before Participants are Scheduled to Arrive

Set up a table to allow 7 people to sit conference-style. In addition, set up 7 secluded areas facing the wall in the room to simulate people working in silos. Set up the charts on the wall or easel and cover up.

### Materials Set-Up

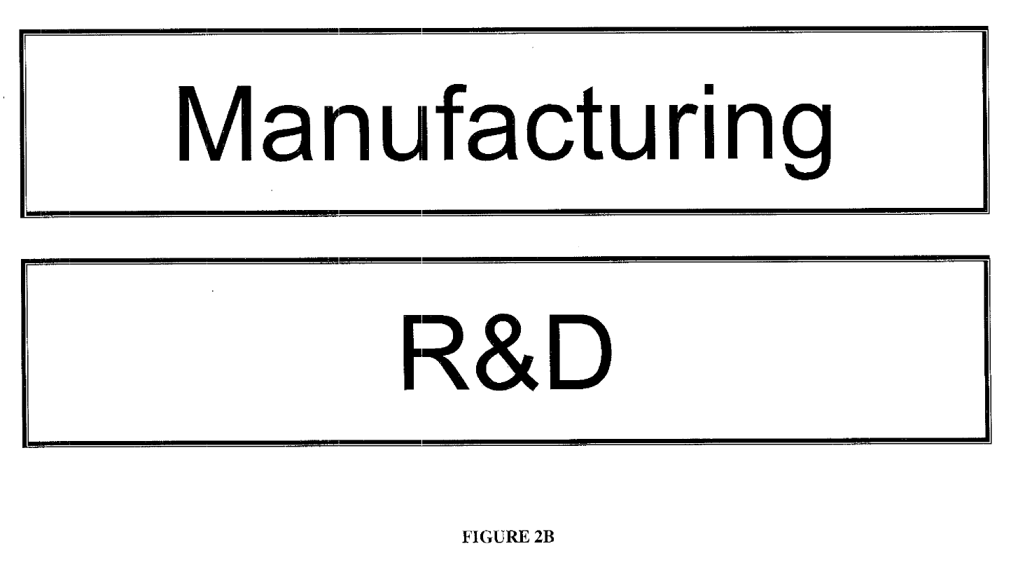

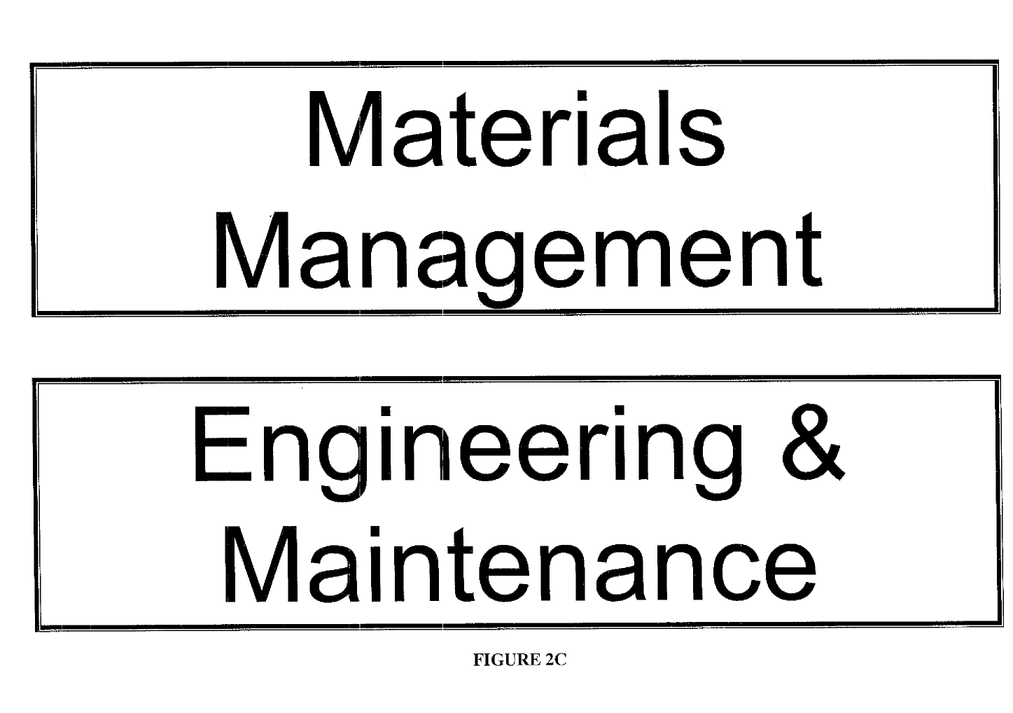

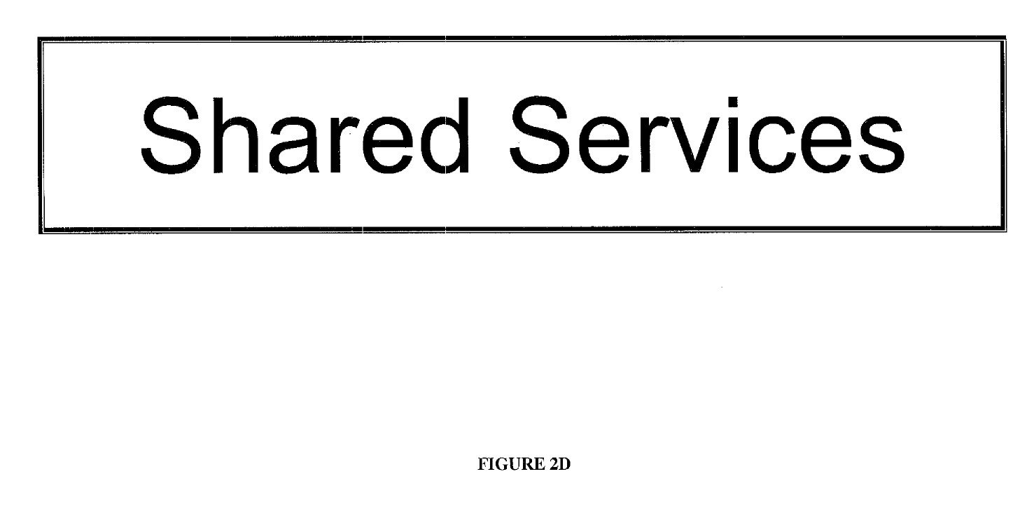

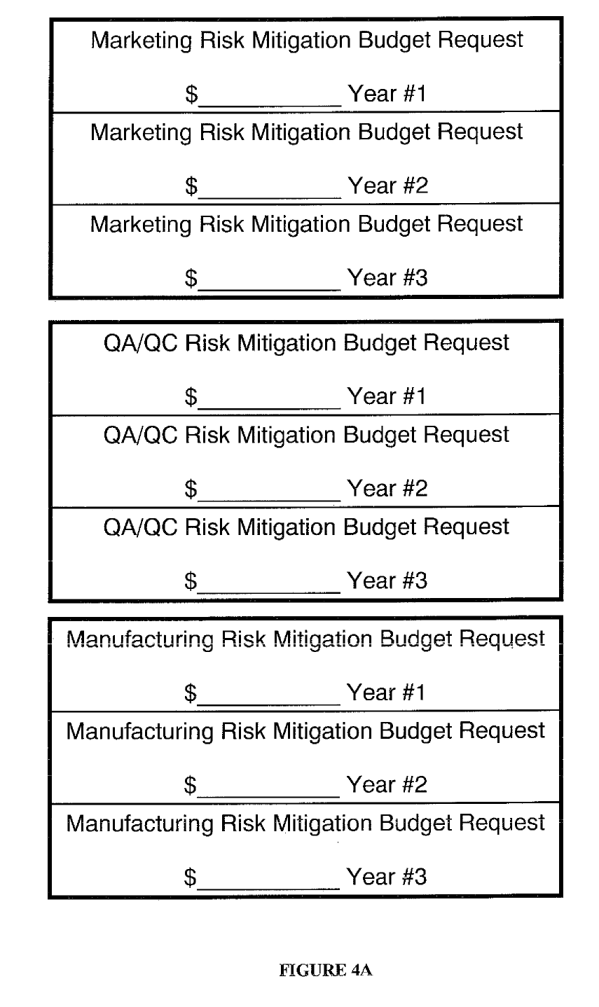

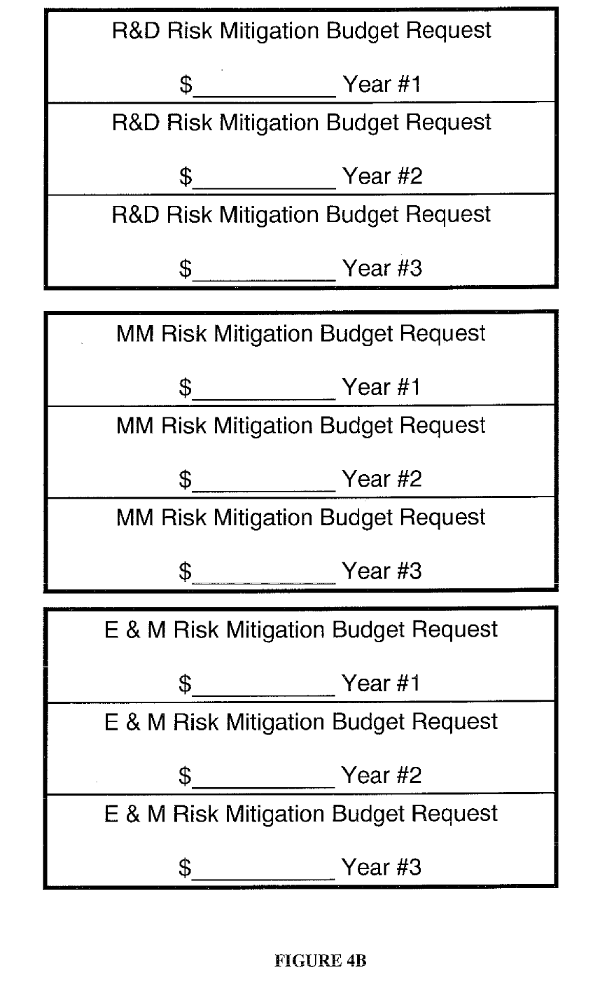

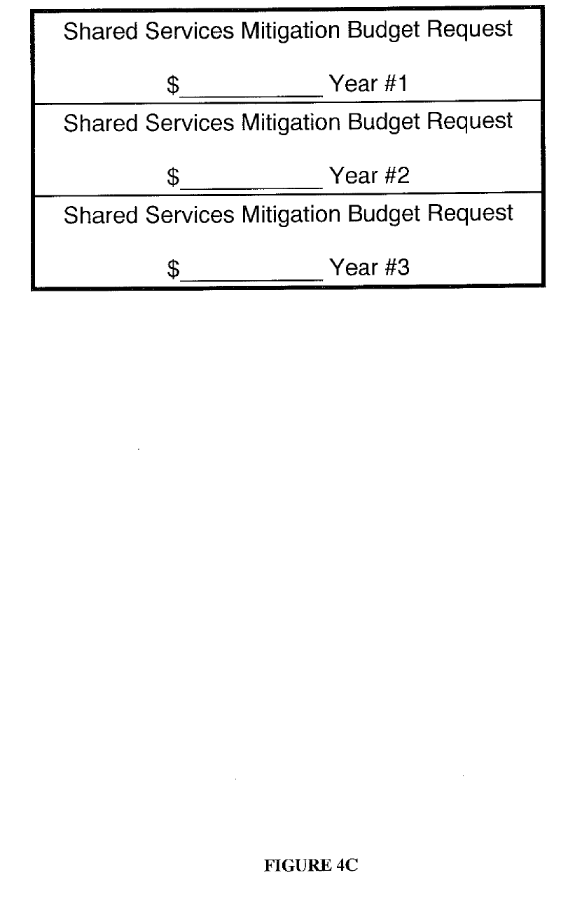

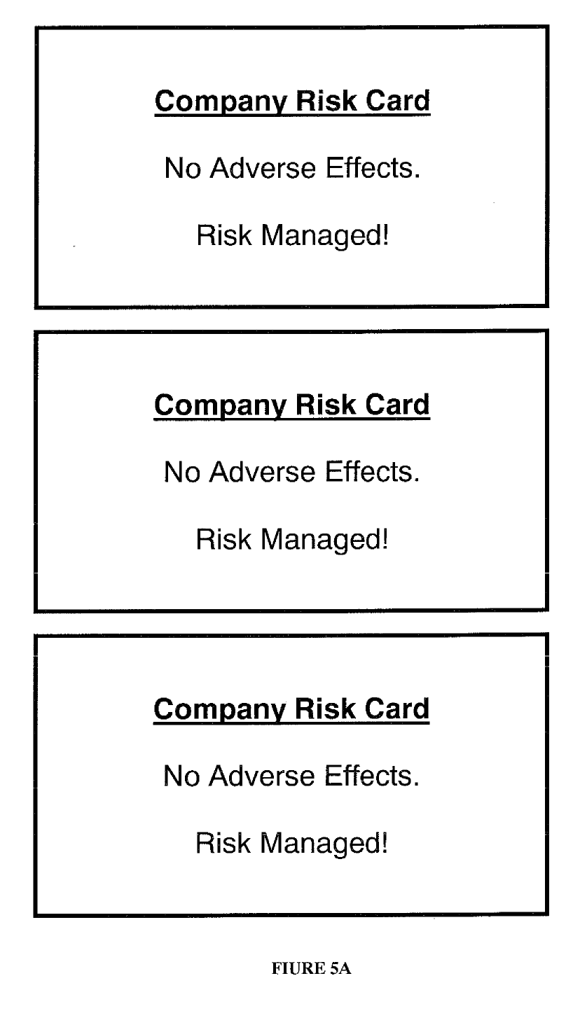

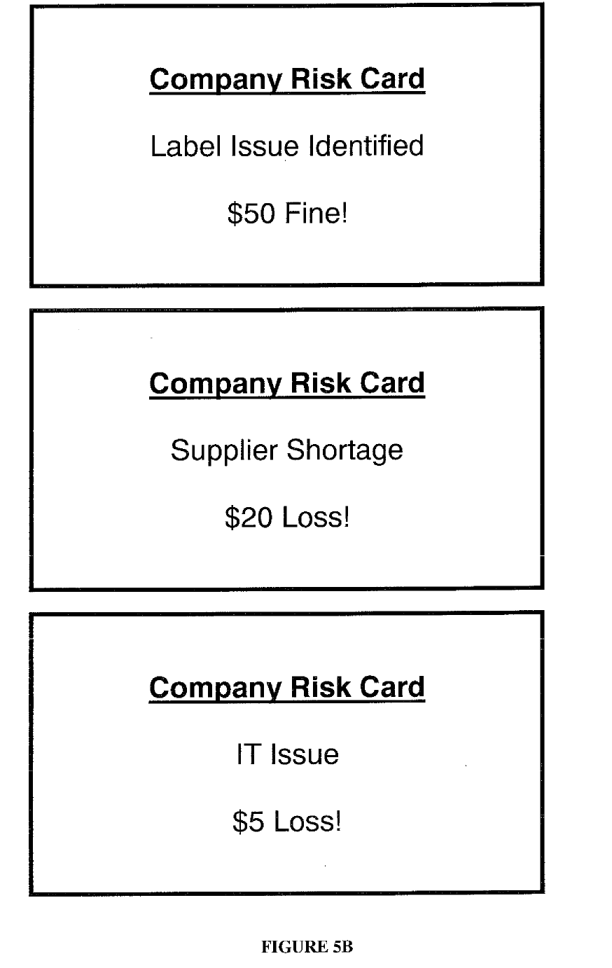

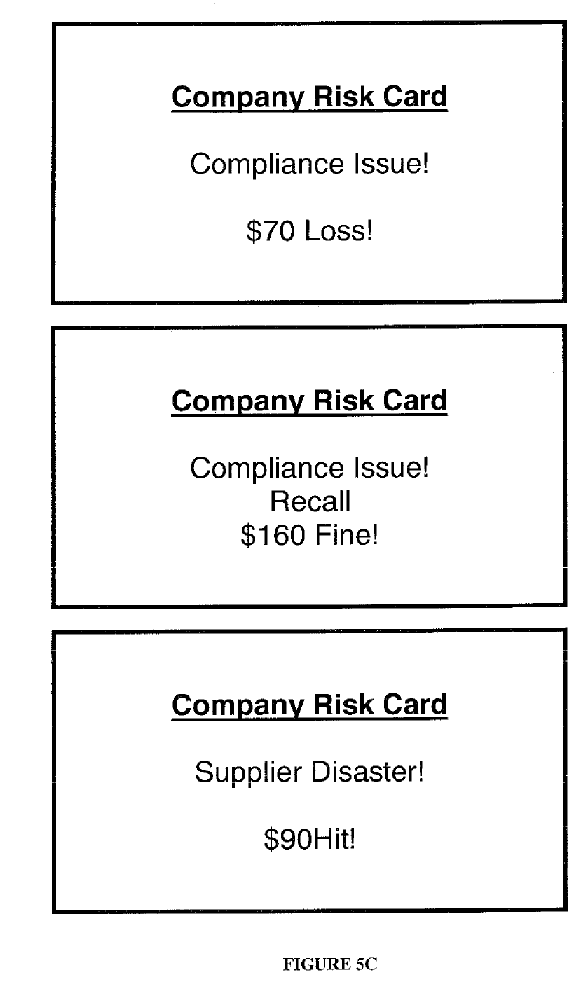

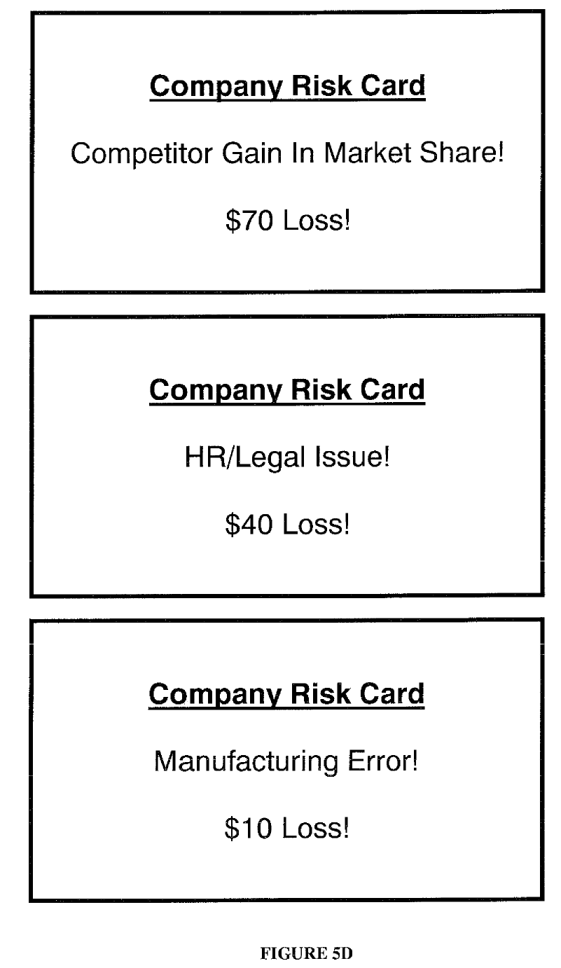

On-Table Materials include: Place holders (FIGS. 2A-2D), all dice, Budget Request cards (FIGS. 4A-4C), Company Risk Impact cards (FIGS. 5A-5D).

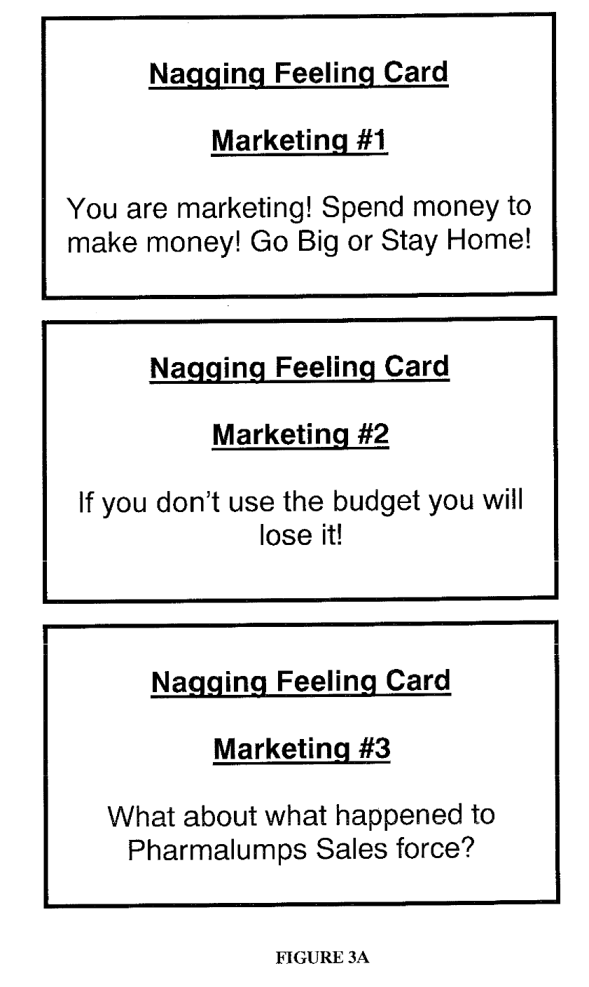

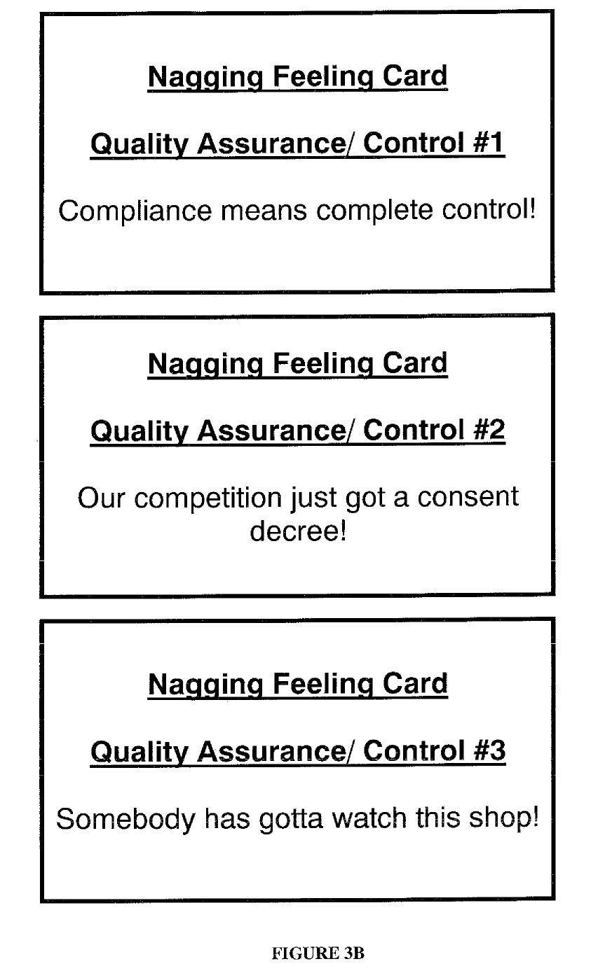

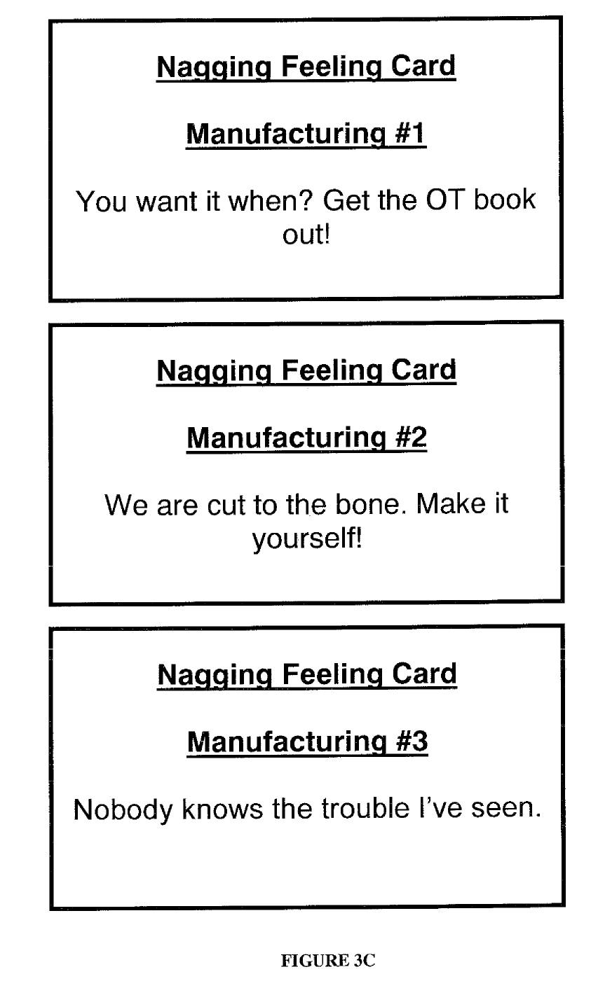

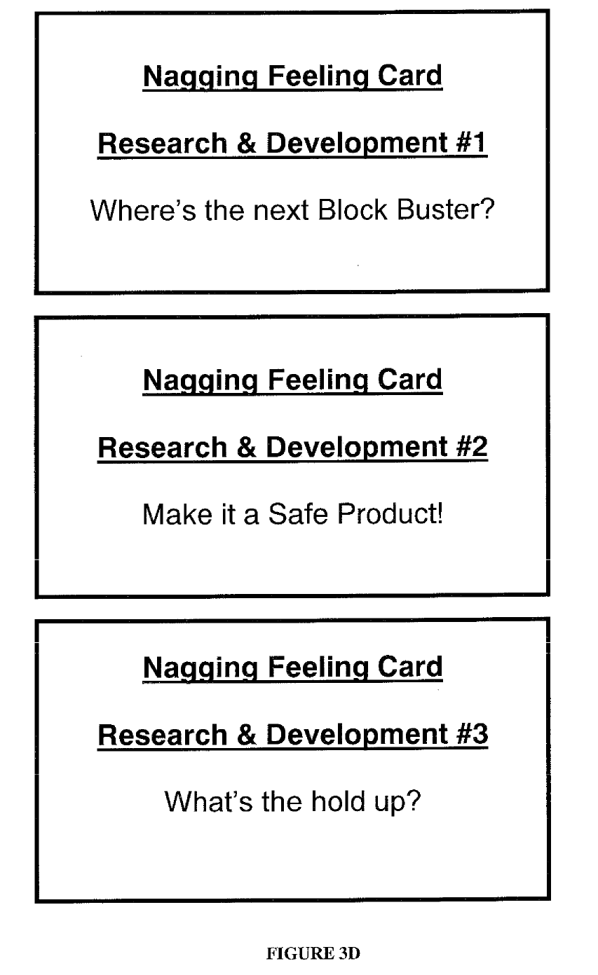

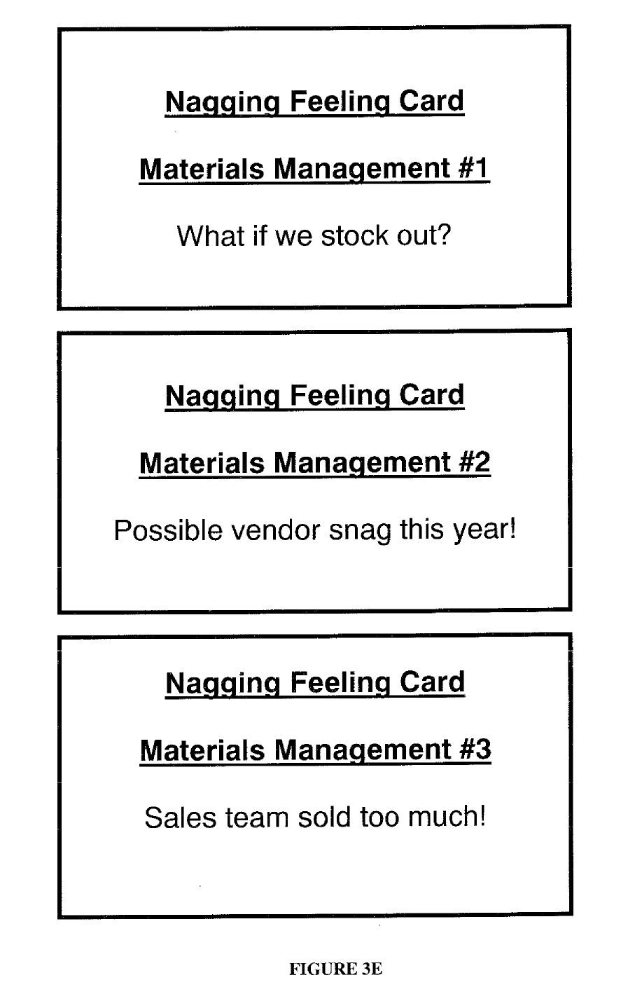

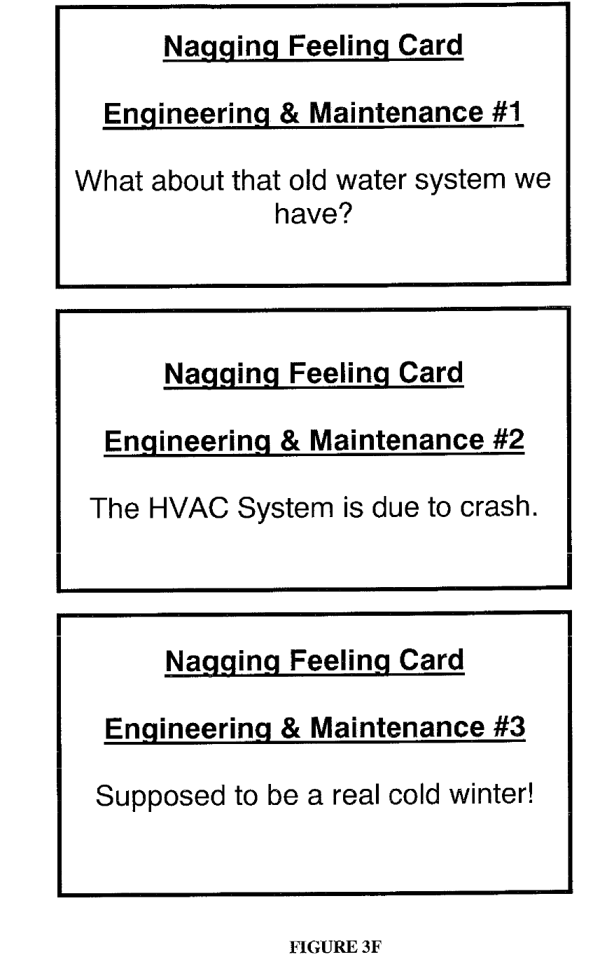

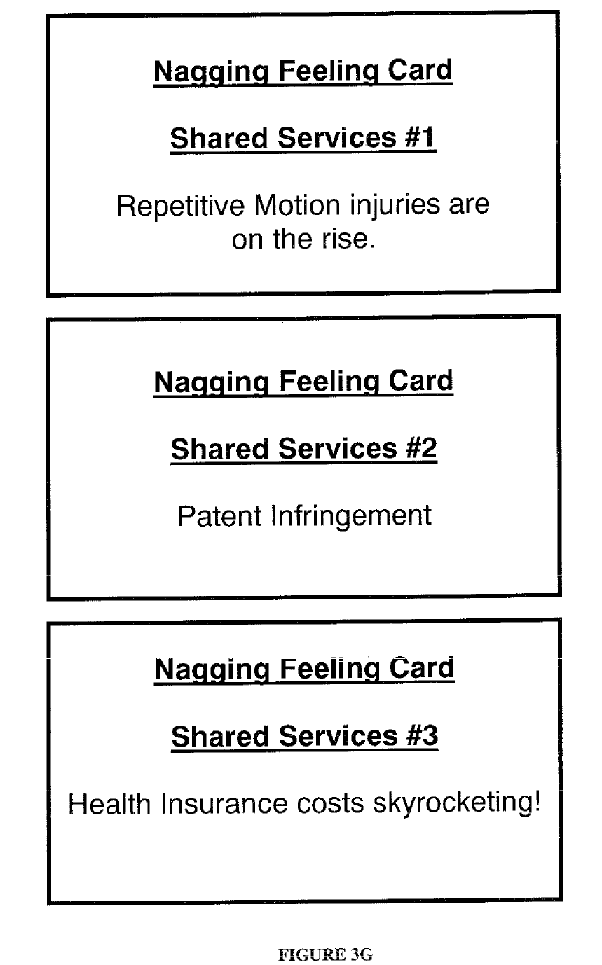

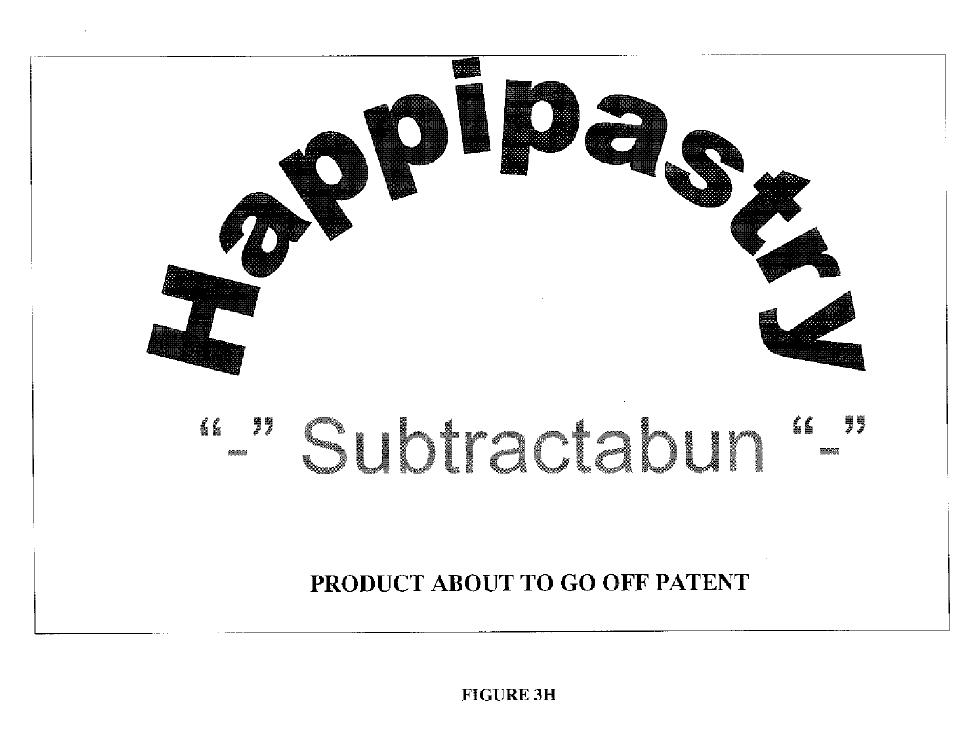

Functional Area Materials include: Year 1 Nagging Feeling cards (FIGS. 3A-3G), Budget Request (FIGS. 4A-4C), pens.

Display opening slide as participants enter the room. Say: “Welcome to Risky Business!!!” (FIG. 7)

### Purpose Opener

Describe why we are here. What is “Risk” and why the need to mitigate it. Describe what we are about to do.

The applicant claims copyright protection in the following portion of the specification:
©Copyright, 2009 Shire Pharmaceuticals, Inc.

### Begin Simulation

Get into the character of being from <add your firm name> or Happipastry Company.

Say: <add your firm name> company is having their annual budget meeting and all the heavy hitters are here. You all are the heavy hitters. Introduce each function:
Marketing (Johnny or Jane Talksalot)
Quality Assurance/Quality Control (Jimmy or Joanie Tightknickers)
Manufacturing (Mr. or Ms. Makethestuff)
R&D (Tim or Tanya Thinkerman)
Material Management (Paul or Pauline Movesumstuff)
Engineering & Maintenance (Justin or Justine Doit)
Shared Services (Gene Green)

Model the exercise. Start the participants at the Corporate Headquarters (Conference Table).
Say: Happipastry is in a bit of a budget-tightening year, so they need each department or function to estimate what they need for Risk Mitigation Spend from a total budget of $150. No talking or questions between the department heads functions or to me. This is a solitary exercise this year, however, the more you spend the more risk you can mitigate. This is a fact in this simulation. I am going to give you some instructions and then you, as department heads, will need to quickly execute. In a moment, please go to your designated department or functional home marked with the same functional heading that you are sitting at currently. Then, read your Nagging Feeling card. After that, enter your annual risk budget request for your department on your card. Each department or function should do their estimate in increments of $5. Remember, better safe than sorry, and no questions. You should know your job, so go, and do it!
Say: Alright, let's wrap it up and report to corporate headquarters for our annual budget meeting. Bring your Risk Mitigation Budget Request, your Nagging Feeling card, and sit at the place marked with your department or function.

Uncover the year-one Risky Business Scorecard and record the year on the Risky Business Scorecard.

### Year #1: Isolated Silos, Little or No Risk/Profit Balance Understanding

Say: In seated order starting with Marketing, please read your Nagging Feeling card, then tell me your Budgetary Request for Year One. Record the budgetary requests on the scorecard in the Annual Budget Request column.

The support person should divide the budgetary requests by 5 and instruct each participant to roll that number of dice.

In order around the table starting with Marketing, roll the dice, record the roll count, and answer whether they rolled over their departmental risk mitigation requirement. To determine departmental risk mitigation requirement, add the sum of the dice, and if the sum is greater than or equal to the number in the Departmental Risk Mitigation column, then circle “Yes” on the board and do not take a company risk card. If the sum of the dice is less than the number in the Departmental Risk Mitigation column, then circle “No” on the board, and the participant is required to draw the number of Company Risk Impact Cards that they are under the required roll, (e.g., if the roll count is 8 and the requirement is 10, the participant then takes 2 Company Risk Impact Cards). Mark the Company Risk Impact Card effect(s) in the appropriate Company Risk Card Impact column on the Risky Business Scorecard of FIG. 6. Continue in order to the next person until completed.

When all rolls have been completed, total the entire die count in the total box at the bottom of the Roll Count column and answer the Company Risk Mitigation Question to the right of the total box. If the total roll count is under 60, select any participant to draw the number of Company Risk Impact Cards under 60. For instance, if the total roll count equals 57, then a participant draws 3 Company Risk Impact Cards and you record the results in the Company Risk Card Impact column in FIG. 6. The support person should total the annual budget requested and you should place the dollar figure in the box under Annual Risk Spend. Total the Company Risk Impact Card effects and put the dollar figure in the Company Risk Impact Card effects dollar total in FIG. 6.

Have the Marketing participant step up to the Dart Revenue Determiner (dart board (FIG. 11)). Have them throw the dart.

Dart Value: Blue $500
White $750.
Bullseye $1000

Other dart board separations can be used as appropriate as long as the dollar figures are maintained. An electronic dart board with plastic-tipped darts is highly suggested for safety reasons.

Place the Annual Revenue in the box at the bottom of the Annual Revenue Column.

Subtract the sum of the Annual Risk Spend and Company Risk Card Impact from the Annual Revenue and place the number in the net profits section to finish the year.

Comment briefly on the state of the year and ask the participants to return to their functional areas without talking.

### Year #2: Better Intuitive Understanding

Do not allow participants to move their functional area chairs at this time, but allow them to talk strategy for 60 seconds from functional areas, using the timer to time the time period. Have participants read the Nagging Feeling Card number 2. Then have the participants write their budget figure on a supplied Risk Mitigation Budget Request form.
Say: Alright, let's wrap it up and report to corporate headquarters for our annual budget meeting, bring your Risk Mitigation Budget Request, your Nagging Feeling card, and sit at the place marked with your function.

Uncover the year-two Risky Business Scorecard, and then record the year on the Risky Business Scoreboard.
Say: In seated reverse order, starting with Shared Services, please read your Nagging Feeling card, then tell me your Budgetary Request for year-two.

Record the budgetary requests on the scoreboard in the Annual Budget Request column.

The support person should divide the budgetary requests by 5 and give each participant that number of dice.

In reverse order around the table, starting with Shared Services, roll the dice, record the roll count, and answer whether they rolled over the departmental requirement. To determine departmental requirement, add the sum of the dice, and if the sum is greater than or equal to the number in the Departmental Risk Mitigation column, then circle “Yes” on the board and do not take a Company Risk Impact Card. If the sum of the dice is less than the number in the Departmental Risk Mitigation column, then circle “No” on the board, and the participant is required to draw the number of Company Risk Impact Cards that are under the required roll, (e.g., if roll count is 8 and the requirement is 10, then the participant takes 2 Company Risk Impact Cards). Mark the Company Risk Impact Card effect(s) in the appropriate Company Risk Card Impact column. Continue in order to the next person until completed.

When all rolls have been completed, total the entire die count in the total box at the bottom of the Roll Count Column and answer the Company Risk Mitigation Question to the right of the total box. If the total roll count is under 60 select any participant to draw the number of Company Risk Impact Cards under 60, (e.g. if the total roll count equals 57, then a participant draws 3 Company Risk Impact Cards and records the results in the Company Risk Card Impact column in FIG. 6.

The support person should total the annual budget requested and place dollar figure in the box under Annual Risk Spend, total the Company Risk Impact Card effects, and put the dollar figure in the Company Risk Impact Card effects dollar total in FIG. 6.

Ask a participant to step up to the Dart Revenue Determiner (dart board (FIG. 11)). Have them throw the dart.

Dart Value: Blue $500
White $750
Bullseye $1000

Place the Annual Revenue in the box at the bottom of the Annual Revenue column.

Subtract the sum of the Annual Risk Spend and Company Risk Card Impact from the annual Revenue and place the number in the net profits section to finish the year.

Comment briefly on the state of the year and ask the participants to return to their functional areas without talking.

### Year 3: Training and Functional Communication and Understanding of Risks

Pass out one training aid (FIG. 10) to each participant and train the participants on the use the training aid. Go block by block from left to right then down to the second row left to right and explain the concepts. Answer any and all questions for 3 minutes (use timer). Ask the participants to report back to their functional areas, but now have them turn their chairs around to face each other and allow the participants to talk to each other for another 2 minutes (use timer).

Have participants read the Nagging Feeling card up on the poster that Happipastry's biggest product, a weight-loss pastry, Subtractabun, is about to go off patent (FIG. 3H). Then have the participants write their budget figure on a supplied Risk Mitigation Budget Request form.
Say: Alright, let's wrap it up and report to corporate headquarters for our annual budget meeting, bring your Risk Mitigation Budget Request, your Nagging Feeling card, and sit at the place marked with your function.

Uncover the year-three Risky Business Scorecard, and then record the year on the Risky Business Scorecard.
Say: In seated, reverse order, starting with Shared Services, please read your Nagging Feeling card, then tell me your Budgetary Request for year-three.

Record the Budgetary Requests on the scoreboard in the Annual Budgetary Request column.

The support person should divide the budgetary requests by 5 and give the each participant that number of dice.

In reverse order around the table, starting with Shared Services, roll the dice, record the roll count, and answer whether they rolled over their departmental requirement. To determine departmental requirement, add the sum of the dice, and if the sum is equal to or greater than the number in the Departmental Risk Mitigation Column, then circle “Yes” on the board and do not take a company risk card. If the sum of the dice is less than the number in the Departmental Risk Mitigation Column, then circle “No” on the board, and the participant is required to draw the number of Company Impact Risk Cards that they are under the required roll, i.e. if roll count is 8 and the requirement is 10, then the participant takes 2 Company Risk Impact Cards. Mark the Company Risk Impact Card effect(s) in the appropriate Company Risk Card Impact column of FIG. 6. Continue in order to the next person until completed.

When all rolls have been completed, total the entire die count in the total box at the bottom of the Roll Count Column and answer the Company Risk Mitigation Question to the right of the total box. If the total roll count is under 60 select any participant to draw the number of Company Risk Impact Cards under 60, (e.g. if the total roll count equals 57 then a participant draws 3 Company Risk Impact Cards and record the results in the Company Risk Card Impact column).

The support person should total the annual budget requested and place the dollar figure in the box under Annual Risk Spend. Total the Company Risk Impact Card effects and put the dollar figure in the Company Risk Impact Card effects dollar total in FIG. 6.

Ask a participant to step up to the Dart Revenue Determiner (dart board (FIG. 11)). Have them throw the dart.

Dart Value: Blue $500
White $750
Bullseye $1000

Place the Annual Revenue in the box at the bottom of the Annual Revenue column.

Subtract the sum of the Annual Risk Spend and Company Risk Card Impact from the annual Revenue and place the number in the net profits section to finish the year.

Comment briefly on the state of the year and ask the participants to return to their functional areas without talking.

### Year 3: Debrief

Ask the following questions:
How did the team progress through the years?
What was the value of having a clear plan, clear communication, and training for managing risk?
What did you see in the simulation that compares to how we handle risk?
Which do you think would be more effective, a nagging feeling, or sound data and communication?
Did you feel the team pushed its luck, or reasonably mitigated risk?
What year most signifies where we operate currently as a company/department?
What factors in the later years allowed you to manage risk and still maximize profits?
What was the single most contributing factor to maintaining the balance of risk and profits?
How could we improve how we view, manage, and mitigate risk?

Have participants take part in industry-related, comprehensive risk management training of applicable length.

### Year 4: Post-Risk Management Training Application of Communication and Understanding of Risks (Optional Year)

Have participants read the nagging feeling card number 3. Then have the participants write their budget figure on a supplied Risk Mitigation Budget Request form (no space provided).
Say: Alright, let's wrap it up and report to corporate headquarters for our annual budget meeting, bring your Risk Mitigation Budget Request, your Nagging Feeling card, and sit at the place marked with your function.

Uncover the year-four Risky Business Scorecard, and then record the year on the Risky Business Scorecard.

### Year 4

Say: In seated, reverse order, starting with Shared Services, please read your Nagging Feeling card, then tell me your Budgetary Request for year-four.

Record the Budgetary Requests on the scoreboard in the Annual Budgetary Request column.

The support person should divide the budgetary requests by 5 and give the each participant that number of dice.

In reverse order around the table, starting with Shared Services, roll the dice, record the roll count, and answer whether they rolled over their departmental requirement. To determine departmental requirement, add the sum of the dice, and if the sum is greater than or equal to the number in the Departmental Risk Mitigation Column, then circle “Yes” on the board and do not take a company risk card. If the sum of the dice is less than the number in the Departmental Risk Mitigation Column, then circle “No” on the board, and the participant is required to draw the number of Company Risk Impact Cards that they are under the required roll, (e.g., if roll count is 8 and the requirement is 10, then the participant takes 2 Company Risk Impact Cards). Mark the Company Risk Impact Card effect(s) in the appropriate Company Risk Card Impact column in FIG. 6. Continue in order to the next person until completed.

When all rolls have been completed, total the entire die count in the total box at the bottom of the Roll Count Column and answer the Company Risk Mitigation Question to the right of the total box. If the total roll count is under 60 select any participant to draw the number of Company Risk Impact Cards under 60, (e.g. if the total roll count equals 57 then a participant draws 3 Company Risk Impact Cards) and record the results in the Company Risk Card Impact column.

The support person should total the annual budget requested and place the dollar figure in the box under Annual Risk Spend. Total the Company Risk Impact Card effects and put the dollar figure in the Company Risk Impact Card effects dollar total.

Ask a participant to step up to the Dart Revenue Determiner (dart board (FIG. 11)). Have them throw the dart.

Dart Value: Blue $500
White $750
Bullseye $1000

Place the Annual Revenue in the box at the bottom of the Annual Revenue column.

Subtract the sum of the Annual Risk Spend and Company Risk Card Impact from the annual Revenue and place the number in the net profits section to finish the year.

Ask players whether they feel that they have learned concepts of risk and reward by playing the game, and tell them the game has concluded.

Although a preferred embodiment of the invention has been described, the invention is not limited to the embodiment illustrated, and its scope is defined only by the following claims and equivalents thereof.

1. A method of playing a risk/reward game to simulate the impact of risk and reward events by players while managing different departments of a multi-department business enterprise, comprising the steps of:
assigning each player to be the head of a different department in a business enterprise;
providing each player with a risk indicia representing a possible risk-event associated with the player's department in the enterprise;
receiving from each player a requested budget amount to spend to address risk associated with the player's department based on the player's perceived risk;
providing each player with a physical random number-generated device to generate a random number value, the range of possible random number values being determined by the player's requested budget amount;
generating a random number value for each player using the random number generator device;
determining whether the random number value for each player is at least as great as a department risk mitigation value associated with the player's respective department, and if not at least as great, provide each such player with a number of department-specific risk impacts, the number being dependent on the amount that such department risk mitigation value is less than the random number value, wherein each said risk impact indicia represent the cost to the enterprise if a risk event occurs;
calculating the value of the total cost to the business enterprise of all of the risk events of the departments of step f;
determining a value of the total income to the business enterprise based on a physical skill event by at least one of the players using physical game devices, the total income value being dependent on the player's performance on the skill event; and
determining a value of the profit for the business enterprise by calculating the difference between the total income value of step h and the total cost value of step g.

2. The method of claim 1, further including the step of determining whether the total of the random numbers generated in step e is at least as great as an enterprise-wide risk mitigation value, and if not at least as great, providing to the players a number of enterprise-wide risk impact indicia, the number being dependent on the amount that such enterprise-wide mitigation value is less than a specific enterprise-wide set value, wherein said enterprise-wide risk impact indicia represents the cost to the business enterprise if a risk event occurs, and wherein step g includes calculating a value of the total cost to the business enterprise, which includes the cost of the enterprise-wide risk event.

3. The method of claim 1, wherein the step of providing each player with a physical random number generator comprises providing each player with a number of game die the number being dependent on the player's requested budget amount for the player's department.

4. The method of claim 1, wherein the step h comprises providing a physical dart board with target areas having assigned different total income values, and at least one dart.

5. The method of claim 1, further including the step of precluding communication between players in the game throughout the steps, to simulate players working independently in their own departments without communication or cooperation with other departments.

6. The method of claim 1, further including requiring the players to communicate during the game to foster cooperation in each player in requesting a budget amount for each player's department.

7. The method of claim 1, including a first round of play of steps a-i, during which players are precluded from communication, and a second round of play repeating steps h-i, during which players are required to communicate to foster communication and cooperation in each player requesting a budget amount for each player's department.

8. The method of claim 7, including a third round of play repeating steps h-i, and including the step of communicating to the players the concept of the game to help them understand how to maximize the net profit before the third round.

9. The method of claim 8, including a fourth round of play repeating steps h-i, and including the step of requesting players to engage in self-critical analysis and to identify factors they perceive important in improving performance, before the fourth round.

10. A risk/reward game to simulate the impact of risk and reward events by players while managing different departments of a multi-department business enterprise, comprising:
department identification signs which identify different departments in a business enterprise and where a player assigned to be the department head will be located during the game;
a plurality of risk indicia cards for each department, each risk indicia card for a department representing a possible risk event associated with the player's department in the enterprise,
a budget request card for each department for recording from each player a requested budget amount to spend to address possible risk events associated with the player's department;
a physical random number-generated device, to generate a random number value, the range of possible vendor number values being determined by the player's requested budget amount, and used by a player to generate a random number;
a score card having locations for recording the random number value for each player, evaluating whether the random number value is at least as great as a department risk mitigation value associated with the player's respective department, determining any difference between the random number value and department risk value to arrive at a number of risk events attributable to the player, and wherein the scorecard also has locations for recording other number values in the rest of the game;
a plurality of department-specific risk impact indicia for each department to be given to respective department player, wherein the number of department-specific risk impact indicia given to a player is dependent on the amount that such department risk mitigation value is less than the random number value, wherein each risk impact indicia has a value which represents the cost to the enterprise if a risk event occurs;
wherein the score card has locations for recording the calculated value of the total cost to the enterprise of all of the risk events of the departments;
a physical skill device to be used by at least one of the players for determining the value of the total income to the enterprise based on a physical skill event by at least one of the players using the physical skill device, the total income value being dependent on and proportional to the player's skill and performance using the skill device;
wherein the net profit to the business enterprise is determined by the difference between the total income value, minus the sum of the department budget requests, and minus the total values of the risk events that have actually occurred as indicated by the values of the costs of the risk events for all of the players and recorded on the scorecard.

11. The game of claim 10, wherein the physical random number generator comprises a number of game die, and wherein the number of game die used by the player is determined by the player's requested budget amount.

12. The game of claim 10, wherein the skill device comprises a physical dart board having target areas with different values, which target areas with higher values being smaller in size and more difficult to obtain, and at least one dart.

13. The game of claim 10, further including a number of enterprise-wide risk impact indicia each representing the cost to the business enterprise if a risk event occurs, wherein the number of enterprise-wide risk impact indicia being given to the players is determined by how much greater a specific enterprise-wide set value is greater than the total of the random numbers for all players, and wherein the net profit of the enterprise is determined by also subtracting the cost of the business enterprise risk impact indicia given to the players.
